(19) United States
(12) Patent Application Publication
(10) Pub. No.: US 2026/0337300 A1
(43) Pub. Date: Oct. 29, 2026

(54) PROCESSES OF MAKING CELLULOSE ESTER FIBERS FROM PRE-CONSUMER TEXTILE WASTE

(71) Applicant: Eastman Chemical Company, Kingsport, TN (US)

(72) Inventors: Glen Douglas Wagner, Jonesborough, TN (US); Trevor Hobbs Treasure, Kingsport, TN (US); John Michael Allen, Kingsport, TN (US); Brian Tyndall Edwards, Jonesborough, TN (US); Perry Michael Murdaugh, Johnson City, TN (US); Robert Lin, Kingsport, TN (US); Neil Warren Boaz, Kingsport, TN (US); Kevin Leonard Urman, Gonzalez, FL (US)

(73) Assignee: Eastman Chemical Company, Kingsport, TN (US)

(21) Appl. No.: 19/107,084

(22) PCT Filed: Aug. 29, 2023
(86) PCT No.: PCT/US2023/073040

§ 371 Date: Feb. 27, 2025

Related U.S. Application Data
(60) Provisional application No. 63/374,091, filed on Aug. 31, 2022.

(51) Int. Cl. C08B 3/06; C08B 1/02; C08J 11/26; D01D 5/04; D01D 5/06

(52) U.S. Cl. CPC C08B 3/06; C08B 1/02; C08J 11/26; D01D 5/04; D01D 5/06; C08J 2301/02; D10B 2201/28

(57) ABSTRACT

A dissolving pulp comprising a pre-consumer textile waste is used to produce cellulose esters and corresponding fibers. The process utilizes the cellulose content of wastes generated during textile manufacturing, including cotton linters, undercard, fabric clippings, cattle feed waste, comber knolls, pneumafil waste, shoddy waste, yarn waste, production waste, cutter clippings, twisting waste, or mixtures thereof.

### BACKGROUND

### 1. Field

The present application is generally related to the use dissolving pulps derived from waste textiles in cellulose ester production.

### 2. Description of the Related Art

Dissolving-grade wood pulp raw materials are generally used to manufacture cellulosic fibers used in consumer textiles. While there are sustainably managed forests from which to obtain at least some of the required wood pulp supply, that is not ideal. Additionally, the global textiles industry generates substantial quantities of waste textiles that end up in landfills or incinerated each year. There is a need for technologies that reduce the use of wood pulp while simultaneously decreasing landfill contributions and polluting incineration processes.

### SUMMARY

In one embodiment, the present disclosure provides a process comprising reacting an esterification agent with cellulose to form a cellulose ester. At least a portion of the cellulose is derived from a pre-consumer textile waste.

In another embodiment, the disclosure provides a process for producing a cellulose ester fiber. The process comprises breaking a roll and/or sheet of a dissolving pulp comprising recycled pre-consumer textile waste that comprises cellulose into smaller pieces. The cellulose is reacted with an esterification agent so as to form a cellulose ester. A dope comprising the cellulose ester is spun through a spinneret to make one or more cellulose ester fibers.

The disclosure also provides a cellulose ester fiber made from one of the above processes. In a further embodiment, the disclosure provides an article comprising the cellulose ester fiber.

### DETAILED DESCRIPTION

The present application generally relates to a cellulose ester preparation process that utilizes pre-consumer textile waste. In one embodiment, the disclosed process comprises reacting an esterification agent with cellulose pulp derived from a pre-consumer textile waste to form a cellulose ester.

Pre-consumer textile waste may be waste generated by the commercial textile industry during the processing of cotton-based fibers, such as during garment, fabric, and/or yarn manufacturing. Pre-consumer textile waste may comprise any off-class material from any step in the manufacturing process: carding through to the final manufacturing steps of the particular process. Waste generated by the commercial textile industry during startup and/or shutdown of a manufacturing process and/or during transition to a new material. Pre-consumer textile waste can be differentiated from post-consumer textile waste in that latter includes garments that were fabricated and passed to, and/or used by, consumers. Pre-consumer textile waste may comprise, consist essentially of, or consist of one or more of cotton linters, undercard, fabric clippings, cattle feed waste, comber knolls, pneumafil waste, shoddy waste, yarn waste, production waste, cutter clippings, twisting waste, or mixtures thereof.

Cotton ginning leaves short cellulose fiber on the seed after staple cotton is removed by ginning or other separation methods. These fibers are referred to as cotton linters, and cotton linters are a pre-consumer textile waste that may be used as a dissolving pulp, as described in this disclosure.

In the cotton textile spinning process, short fibers, seed waste, and stems are removed before the spinning process. The opening and carding equipment used for this process has a filtration extraction system that removes and collects these particles. In the process of separating the good fiber from the external particles, some fiber is generally still captured. Undercard includes this fiber, and is a pre-consumer textile waste that may be used to prepare cellulose esters as described herein.

Each textile cutting operation has a pattern that is cut from a standardized width of fabric, leaving scraps of the fabric that does not become part of the final garment and would likely be discarded as waste. Many of these fabrics were originally formed from a cellulosic material. Fabric clippings such as these are a pre-consumer textile waste that may be used to prepare cellulose esters as described herein. T-shirt clippings are an example of a fabric clipping that would be suitable for use as a pre-consumer textile waste.

Cattle feed waste includes heavy seed and stem cotton trashier than undercard. Comber knolls includes good cotton but with short fibers of ½ inch (1.27 cm) or shorter. Pneumafil waste comprises fiber collected at drawing or spinning during processing.

Shoddy waste comprises reprocessed fabric chopped into smaller pieces and torn back into fibers. Yarn waste comprises waste generated from off standard (e.g., not normal or usual) or cut packages. Twisting waste includes that captured at twisting for multiple ends and/or final package winding.

Production waste comprises material that is off standard (e.g., off shade, wrong weight fabric, broken needle runs, etc.). Cutter clippings comprise material from cut patterns that is not used to make garments.

In one embodiment, the pre-consumer textile waste may be in the form of a dissolving pulp. The dissolving pulp may be provided as a roll or a sheet, and that roll or sheet may contain cellulose from more than one source of pre-consumer textile waste and/or cellulose from a source(s) other than pre-consumer textile waste, such as bamboo, switchgrass, hemp, juice industry waste (such as that left over from the pulping process), sugar cane bagasse, or mixtures thereof.

In one embodiment or in combination with any other mentioned embodiments, at least 1%, at least 20%, at least 50%, at least 70%, at least 85%, at least 90%, or at least 100% by weight of the cellulose in the dissolving pulp will be from a pre-consumer textile waste source.

The roll or sheet of dissolving pulp may be mechanically conditioned prior to acetylation. Mechanical conditioning can include breaking the roll or sheet into smaller pieces (e.g., shredding, chopping). Additionally, multiple rolls or sheets of the same or different types (e.g., having celluloses from different sources, as described above) can be mechanically conditioned to form smaller pieces and combined with the smaller pieces obtained from the pre-consumer textile waste dissolving pulp.

In one embodiment or in combination with any other mentioned embodiments, the pre-consumer textile waste dissolving pulp will comprise not more than 3% by weight, not more than 2% by weight, not more than 1% by weight, not more than 0.5% by weight, not more than 0.1% by weight, or not more than 0% by weight surfactant molecules (charged or uncharged), based on the total weight of the pre-consumer textile waste dissolving pulp.

In one embodiment or in combination with any other mentioned embodiments, the pre-consumer textile waste dissolving pulp will comprise not more than 3% by weight, not more than 2% by weight, not more than 1% by weight, not more than 0.5% by weight, not more than 0.1% by weight, or not more than 0% by weight silicon atoms, based on the total weight of the pre-consumer textile waste dissolving pulp.

In one embodiment, the pre-consumer textile waste dissolving pulp will comprise not more than 3% by weight, not more than 2% by weight, not more than 1% by weight, not more than 0.5% by weight, not more than 0.1% by weight, or not more than 0% by weight silicon atoms and surfactant molecules combined, based on the total weight of the pre-consumer textile waste dissolving pulp.

In one embodiment or in combination with any other mentioned embodiments, the pre-consumer textile waste dissolving pulp will have one, two, three, four, five, six, seven, eight, nine, ten, eleven, or twelve of the properties of Table A, in any combination. In one embodiment or in combination with any other mentioned embodiments, the pre-consumer textile waste dissolving pulp will have all thirteen properties of Table A.

TABLE A

| | | | | |
|---|---|---|---|---|
| Alpha Cellulose, | more than 90 | more than 94 | more than 96 | more than 99 |
| R10+ ½(S10-S18) | | | | |
| Non-cotton fiber | less than 3% | less than 2% | less than 1% | 0% |
| in raw material | | | | |
| feedstock (% by weight) | | | | |
| Cuene IV (dL/g) | 5 to 15 | 6 to 14 | 7 to 13 | 8 to 12 |
| ISO Brightness | more than 75 | more than 80 | more than 85 | more than 90 |
| (%) | | | | |
| Ash (%) | less than 0.2% | less than 0.15% | less than 0.1% | less than 0.06% |
| Iron (ppm) | less than 20 | less than 15 | less than 12 | less than 10 |
| Calcium (ppm) | less than 40 | less than 35 | less than 32 | less than 30 |
| Sodium (ppm) | less than 650 | less than 630 | less than 620 | less than 600 |
| Silicon (ppm) | less than 65 | less than 60 | less than 55 | less than 50 |
| S10 (%) | less than 5% | less than 4% | less than 3% | less than 2% |
| S18 (%) | less than 3% | less than 2.5% | less than 2% | less than 1% |
| DCM | less than 0.3% | less than 0.2% | less than 0.1% | less than 0.03% |
| Extractables (% by weight) | | | | |
| Cellulose II | less than 2% | less than 1.5% | less than 1% | 0% |
| content (% by | | | | |
| weight) | | | | |

Regardless of the pre-consumer textile waste source, the cellulose esters can be produced by any method known in the art. The dissolving pulp may be steeped, such as by dissolving the pulp in water, acetic acid and/or glacial acetic acid, so as to cause the fibers to swell, which may increase chemical reactivity. If mechanical conditioning is carried out, steeping may take place after that mechanical conditioning. In one embodiment, steeping can be carried out at a temperature of at least 15 °C, at least 17 °C, at least 20 °C, at least 23 °C, at least 25 °C, at least 27 °C, or at least 30 °C, and/or not more than 65 °C, not more than 63 °C, not more than 60 °C, not more than 57 °C, not more than 55 °C, not more than 53 °C, or not more than 50 °C. In one embodiment or in combination with any other mentioned embodiments, steeping may be carried out for 30 minutes to 90 minutes, or 50 minutes to 70 minutes. In embodiments where the pulp is dissolved in water, dewatering may be carried out prior to esterification.

Suitable esterification agents may include an acetylating agent, such as acetic anhydride. In one embodiment or in combination with any other mentioned embodiments, a catalyst (e.g., sulfuric acid), an organic acid (e.g., acetic acid), or both a catalyst and acetic acid will be present during acetylation.

In one embodiment or in combination with any other mentioned embodiments, acetylation can be carried out at a temperature of at least 5 °C, at least 7 °C, at least 10 °C, at least 13 °C, at least 15 °C, at least 20 °C, or at least 25 °C, and/or not more than 95 °C, not more than 93 °C, not more than 90 °C, not more than 85 °C, not more than 80 °C, not more than 75 °C, or not more than 70 °C. In one embodiment or in combination with any other mentioned embodiments, acetylation may be carried out for 10 minutes to 3 hours, or 15 minutes to 2 hours.

The foregoing process will yield a cellulose triester (e.g., cellulose triacetate). In embodiments where a secondary ester is desired (e.g., cellulose diacetate), the reaction solution can be subjected to a partial hydrolysis reaction, which will convert cellulose triacetate to cellulose diacetate. This process may comprise adding water to the triacetate solution and heating to at least 40 °C, at least 45 °C, at least 50 °C, at least 55 °C, at least 60 °C, or at least 65 °C, and/or not more than 100 °C, not more than 95 °C, not more than 90 °C, not more than 85 °C, not more than 80 °C, or not more than 75 °C. In one embodiment or in combination with any other mentioned embodiments, hydrolysis may be carried out for 4 hours to 25 hours, or 5 hours to 20 hours. In one embodiment, or in combination with any other mentioned embodiments, hydrolysis may be carried out in the presence of an acid catalyst (e.g., sulfuric acid).

Cellulose esters formed as described herein generally comprise repeating units of the structure:

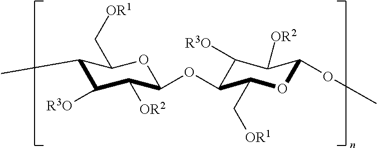

wherein R¹, R², and R³ are selected independently from the group consisting of hydrogen or straight chain alkanoyls having from 2 to 10 carbon atoms. Exemplary alkanoyls include acetyl, propionyl, and/or butyryl.

For cellulose esters, the substitution level is usually expressed in terms of degree of substitution (“DS”), which is the average number of non-OH substituents per anhydroglucose unit (“AGU”). Generally, conventional cellulose contains three hydroxyl groups in each AGU unit that can be substituted; therefore, DS can have a value between zero and three. However, low molecular weight cellulose esters can have a total degree of substitution slightly above 3 due to end group contributions. Because DS is a statistical mean value, a value of 1 does not assure that every AGU has a single substituent. In some cases, there can be unsubstituted AGU's, some with two and some with three substituents. The “Total DS” is defined as the average number of all of substituents per AGU and typically the value will be a non-integer. The degree of substitution per AGU can also refer to a particular substituent, such as, for example, hydroxyl, acetyl, butyryl, or propionyl.

In one embodiment or in combination with any other mentioned embodiments, the cellulose ester comprises a DS_{acetyl} of at least 1.5, at least 1.55, at least 1.6, at least 1.65, at least 1.7, at least 1.75, at least 1.8, at least 1.85, at least 1.9, at least 1.95, at least 2.0, at least 2.05, at least 2.1, at least 2.15, at least 2.2, at least 2.25, at least 2.3, at least 2.35, or at least 2.38 and/or not more than 2.95, not more than 2.9, not more than 2.8, not more than 2.7, not more than 2.6, not more than 2.55, not more than 2.5, or not more than 2.45. In certain embodiments, the cellulose ester may comprise a DS_{acetyl} in the range of 2.7 to 2.95, 1.5 to 2.6, 1.6 to 2.6, 1.7 to 2.6, 1.8 to 2.6, 1.9 to 2.6, 2.0 to 2.6, 2.05 to 2.6, 2.1 to 2.6, 2.15 to 2.6, 2.2 to 2.6, 2.25 to 2.55, 2.3 to 2.5, or 2.38 to 2.45.

Additionally or alternatively, in one embodiment or in combination with any other mentioned embodiments, the cellulose ester comprises a DS_{OH} of at least 0.05, at least 0.1, at least 0.2, at least 0.3, at least 0.4, or at least 0.5 and/or not more than 1.5, not more than 1.4, not more than 1.3. not more than 1.2, not more than 1.1, or not more than 1.0. In certain embodiments, the cellulose ester comprises a DS_{OH} in the range of 0.05 to 1.5, 0.1 to 1.5, 0.2 to 1.4, 0.3 to 1.2, 0.4 to 1.1, or 0.5 to 1.0.

Additionally or alternatively, in one embodiment or in combination with any other mentioned embodiments, the cellulose ester comprises a DS_{butyryl} of at least 0.1, at least 0.2, or at least 0.3 and/or not more than 1.5, not more than 1.4, not more than 1.3, not more than 1.2, not more than 1.1, not more than 1.0, not more than 0.9, not more than 0.8, not more than 0.7, not more than 0.6, not more than 0.5, or not more than 0.4. In certain embodiments, the cellulose ester comprises a DS_{butyryl} in the range of 0.1 to 1.5, 0.1 to 1.2, 0.1 to 0.8, 0.1 to 0.4, 0.2 to 1.5, 0.2 to 1.2, 0.2 to 0.8, 0.2 to 0.4, 0.3 to 1.5, 0.3 to 1.2, 0.3 to 0.8, or 0.3 to 0.6.

Additionally or alternatively, in one embodiment or in combination with any other mentioned embodiments, the cellulose ester comprises a DS_{propionyl} of at least 0.1, at least 0.2, or at least 0.3 and/or not more than 1.5, not more than 1.4, not more than 1.3, not more than 1.2, not more than 1.1, not more than 1.0, not more than 0.9, not more than 0.8, not more than 0.7, not more than 0.6, not more than 0.5, or not more than 0.4. In certain embodiments, the cellulose ester comprises a DS_{propionyl} in the range of 0.1 to 1.5, 0.1 to 1.2, 0.1 to 0.8, 0.1 to 0.4, 0.2 to 1.5, 0.2 to 1.2, 0.2 to 0.8, 0.2 to 0.4, 0.3 to 1.5, 0.3 to 1.2, 0.3 to 0.8, or 0.3 to 0.6.

Additionally or alternatively, in one embodiment or in combination with any other mentioned embodiments, the cellulose ester comprises a Total DS of at least 1.5, at least 1.55, at least 1.6, at least 1.65, at least 1.7, at least 1.75, at least 1.8, at least 1.85, at least 1.9, at least 1.95, at least 2.0, at least 2.05, at least 2.1, at least 2.15, at least 2.2, at least 2.25, at least 2.3, at least 2.35, or at least 2.38 and/or not more than 2.95, not more than 2.9, not more than 2.85, not more than 2.8, not more than 2.75, not more than 2.7, not more than 2.65, not more than 2.6, not more than 2.55, not more than 2.5, or not more than 2.45. In certain embodiments, the cellulose ester may comprise a Total DS in the range of 1.5 to 2.95, 1.6 to 2.85, 1.7 to 2.8, 1.8 to 2.75, 1.9 to 2.7, 2.0 to 2.65, 2.05 to 2.6, 2.1 to 2.6, 2.15 to 2.6, 2.2 to 2.6, 2.25 to 2.55, 2.3 to 2.5, or 2.38 to 2.45.

In one embodiment or in combination with any other mentioned embodiments, the cellulose ester can be a cellulose diacetate and/or cellulose triacetate. Alternatively, in certain embodiments, the cellulose ester can comprise a mixed cellulose ester, such as cellulose acetate butyrate or cellulose acetate propionate.

In one embodiment or in combination with any other mentioned embodiments, the cellulose ester can have a degree of acetylation of at least 30%, at least 35%, or at least 40% by weight and/or not more than 62.5%, not more than 60%, not more than 55%, not more than 50%, or not more than 45% by weight. In certain embodiments, the cellulose ester may have a degree of acetylation in the range of 30% to 62.55%, 35% to 55%, 35% to 50%, 35% to 45%, 40% to 62.55%, 40% to 60%, 40% to 55%, 40% to 50%, or 40% to 45% by weight.

Additionally or alternatively, in one embodiment or in combination with any other mentioned embodiments, the cellulose ester can have a hydroxyl content of at least 0.3%, at least 0.5%, at least 1%, at least 2%, at least 3%, or at least 4% by weight and/or not more than 20%, not more than 15%, not more than 10%, or not more than 5% by weight. In certain embodiments, the cellulose ester may have a hydroxyl content in the range of 0.3% to 20%, 0.5% to 20%, 2% to 15%, 3% to 10%, or 4% to 5% by weight.

In one embodiment or in combination with any other mentioned embodiments, the cellulose ester can have a number average degree of polymerization of at least 100, at least 110, at least 120, at least 130, at least 140, at least 150, at least 160, at least 170, at least 180, at least 190, at least 200, at least 210, at least 220, at least 230, at least 240, at least 250, at least 260, or at least 265. Additionally or alternatively, in one embodiment or in combination with any other mentioned embodiments, the cellulose ester can have a number average degree of polymerization of not more than 1,000, not more than 900, not more than 800, not more than 700, not more than 600, not more than 500, not more than 400, not more than 350, not more than 325, not more than 300, not more than 290, not more than 280, not more than 270, not more than 260, not more than 250, not more than 240, not more than 230, not more than 220, not more than 210, not more than 200, not more than 190, not more than 180, not more than 170, not more than 160, not more than 150, not more than 149, not more than 148, not more than 147, not more than 146, not more than 145, not more than 144, not more than 143, not more than 142, not more than 141, not more than 140, not more than 139, not more than 138, not more than 137, not more than 136, not more than 135, not more than 134, not more than 133, not more than 132, not more than 131, not more than 130, not more than 129, not more than 128, not more than 127, not more than 126, not more than 125, not more than 124, not more than 123, not more than 122, not more than 121, not more than 120, not more than 119, not more than 118, not more than 117, not more than 116, or not more than 115. In certain embodiments, the cellulose ester can have a number average degree of polymerization in the range of 100 to 1,000, 100 to 500, 100 to 400, 100 to 300, 100 to 250, 100 to 200, 100 to 150, 100 to 135, 100 to 200, 100 to 150, 100 to 135, 100 to 180, 100 to 150, 100 to 145, 100 to 140, 100 to 135, or 100 to 130.

In one embodiment or in combination with any other mentioned embodiments, the cellulose ester can comprise a number average absolute molecular weight of at least 5,000 Daltons, at least 10,000 Daltons, at least 15,000 Daltons, at least 20,000 Daltons, or at least 25,000 Daltons and/or not more than 75,000 Daltons, not more than 70,000 Daltons, not more than 65,000 Daltons, not more than 60,000 Daltons, not more than 55,000 Daltons, not more than 50,000 Daltons, not more than 45,000 Daltons, not more than 40,000 Daltons, not more than 35,000 Daltons, or not more than 30,000 Daltons as measured by gel permeation chromatography (“GPC”) according to ASTM D6474. In certain embodiments, the cellulose ester can comprise a number average absolute molecular weight in the range of 5,000 Daltons to 75,000 Daltons, 10,000 Daltons to 65,000 Daltons, or 15,000 Daltons to 35,000 Daltons as measured by GPC according to ASTM D6474.

In one embodiment or in combination with any other mentioned embodiments, the cellulose ester can comprise a weight-average absolute molecular weight of at least 50,000 Daltons, at least 55,000 Daltons, at least 60,000 Daltons, at least 65,000 Daltons, at least 70,000 Daltons, at least 75,000 Daltons, at least 80,000 Daltons, or at least 85,000 Daltons and/or not more than 150,000 Daltons, not more than 140,000 Daltons, not more than 130,000 Daltons, not more than 120,000 Daltons, not more than 110,000 Daltons, not more than 100,000 Daltons, or not more than 95,000 Daltons as measured by GPC according to ASTM D6474. In certain embodiments, the cellulose ester can comprise a weight-average absolute molecular weight in the range of 50,000 Daltons to 150,000 Daltons, 70,000 Daltons to 120,000 Daltons, or 80,000 Daltons to 95,000 Daltons as measured by GPC according to ASTM D6474.

In one embodiment or in combination with any other mentioned embodiments, the cellulose ester can comprise a crystallinity of at least 1%, at least 2%, at least 5%, at least 10%, at least 15%, or at least 20% as measured according to ASTM F2625. Additionally or alternatively, in one embodiment or in combination with any other mentioned embodiments, the cellulose ester can comprise a crystallinity of not more than 25%, not more than 20%, not more than 15%, not more than 10%, not more than 9%, not more than 8%, not more than 7%, not more than 6%, not more than 5%, not more than 4%, not more than 3%, not more than 2%, or not more than 1% as measured according to ASTM F2625. In certain embodiments, the cellulose ester can comprise a crystallinity of 1% to 99%, 1% to 50%, 1% to 30%, 1% to 20%, or 1% to 15% as measured according to ASTM F2625.

In one embodiment or in combination with any other mentioned embodiments, the cellulose ester can exhibit a glass transition temperature of at least 120 °C, at least 125 °C, at least 130 °C, at least 135 °C, at least 140 °C, at least 145 °C, at least 150 °C, at least 155 °C, at least 160 °C, at least 165 °C, at least 170 °C, or at least 175 °C and/or not more than 250 °C, not more than 245 °C, not more than 240 °C, not more than 235 °C, not more than 230 °C, not more than 225 °C, not more than 220 °C, not more than 215 °C, not more than 210 °C, not more than 205 °C, not more than 200 °C, not more than 195 °C, not more than 190 °C, or not more than 185 °C.

In one embodiment or in combination with any other mentioned embodiments, the cellulose ester can comprise a hemicellulose content of at least 0.1%, at least 0.25%, at least 0.5%, at least 1%, at least 2%, at least 3%, at least 4%, at least 5%, at least 6%, or at least 7% by weight. Additionally or alternatively, in one embodiment or in combination with any other mentioned embodiments, the cellulose ester can comprise a hemicellulose content of not more than 10%, not more than 9%, not more than 8%, not more than 7%, not more than 6%, not more than 5%, not more than 4%, not more than 3%, not more than 2%, or not more than 1% by weight.

Regardless of whether cellulose triacetate or cellulose diacetate is the desired end product, the cellulose ester flakes may be precipitated from solution, washed, and dried.

In one embodiment or in combination with any other mentioned embodiments, at least 20%, at least 40%, at least 60%, at least 80%, or at least 100% by weight of the cellulose in the flakes may be from a pre-consumer textile waste source.

The cellulose ester may then be formed into a dope, by dissolution in a suitable solvent, for wet spinning or dry spinning through a spinneret into one or more spun fibers. In one embodiment, the cellulose ester (e.g., cellulose triacetate) may be subjected to melt spinning through a spinneret to form one or spun fibers.

In one embodiment, the cellulose ester (I) prepared from a pre-consumer waste textile as described above may be the only cellulose ester added to the dope or subjected to melt spinning. In another embodiment, the cellulose ester (I) may be mixed or blended with a different cellulose ester flakes (II) to form a blend of at least two different cellulose esters.

Alternatively to precipitation and dissolving in the wet or dry spinning embodiments, the cellulose ester may remain in acid-based solution (i.e., acid dope) and used directly in a downstream fiber wet or dry spinning process. In one embodiment, the acid dope may be derived from only pre-consumer textile waste. In another embodiment, acid dopes from one or more other cellulose sources may be blended with an acid dope derived from pre-consumer textile waste(s).

In one embodiment or in combination with any other mentioned embodiments, the different cellulose ester (II) is not formed from cellulose that was derived from a pre-consumer textile waste. The cellulose ester flakes (II) may be formed from a cellulosic material chosen from wood pulp and/or other plant-based cellulose sources. Examples of other plant-based cellulose sources may include bamboo, switchgrass, hemp, juice industry waste (such as that left over from the pulping process), sugar cane bagasse, agricultural residues, or mixtures thereof.

In one embodiment or in combination with any other mentioned embodiments, at least 20%, at least 40%, at least 60%, at least 80%, or at least 100% by weight of the cellulose in the combination of cellulose ester (I) and cellulose ester (II) may be from a pre-consumer textile waste source.

In one embodiment or in combination with any other mentioned embodiments, if the pre-consumer textile waste comprises cotton linters, then the blend of cellulose ester (I) and cellulose ester (II) comprises not more than 95%, not more than 90%, not more than 85%, not more than 80%, not more than 75%, not more than 70%, not more than 65%, or not more than 60% by weight of cellulose ester formed from cellulose derived from cotton linters, based on the total weight of the flake blend.

In one embodiment or in combination with any other mentioned embodiments, the cellulose ester may be added to a dope so that the dope comprises at least 5%, at least 8%, at least 10%, at least 12%, at least 15%, at least 18%, at least 20%, or at least 22% by weight cellulose ester, and/or not more than 35%, not more than 33%, not more than 30%, not more than 29%, not more than 25%, not more than 22%, or not more than 20% by weight cellulose ester, based on the total weight of the dope. In certain embodiments, the cellulose ester dope comprises 5% to 35%, 10% to 35%, 12% to 35%, 15% to 35%, or 25% to 35% by weight of cellulose ester, based on the total weight of the dope.

The dissolution solvent should be added in sufficient quantities so as to effectively dissolve the cellulose ester, thereby forming the cellulose ester dope. In one embodiment or in combination with any other mentioned embodiments, the cellulose ester dope can comprise at least 65%, at least 70%, at least 75%, at least 80%, at least 85%, at least 90%, or at least 95%, or 99% and/or not more than 99%, not more than 95%, not more than 90%, or not more than 85% by weight of one or more dissolution solvents, based on the total weight of the dope. In certain embodiments, the cellulose ester dope comprises 65% to 99%, 70% to 95%, 75% to 95%, 80% to 95%, or 90% to 99% by weight of one or more dissolution solvents, based on the total weight of the dope.

The dissolution solvent may be any solvent(s) in which the particular cellulose ester is readily soluble. Examples of suitable dissolution solvents for cellulose diacetate include those chosen from acetone, methylene chloride, alcohols (e.g., methanol, ethanol), tetrahydrofuran, dimethylformamide, dimethylacetamide, formamide, N-formylmorpholine, N-methyl-2-pyrrolidone, N-methylformamide, N-vinylacetamide, or N-vinylpyrrolidone, methyl ethyl ketone, cyclohexanone, diacetone alcohol, ethylene glycol diacetate, or mixtures thereof. Examples of suitable dissolution solvents for cellulose triacetate include those chosen from chloroform, methylene chloride, alcohols (e.g., methanol, ethanol), dimethylacetamide, dimethylformamide, formamide, N-formylmorpholine, N-methyl-2-pyrrolidone, N-methylformamide, N-vinylacetamide, or N-vinylpyrrolidone, or mixtures thereof.

The water or moisture content of the dope may be kept relatively low. In one embodiment or in combination with any other mentioned embodiments, the cellulose ester dope has a moisture content of not more than 4%, not more than 3.5%, not more than 3%, not more than 2.5%, not more than 2%, not more than 1.5%, not more than 1.4%, not more than 1.3%, not more than 1.2%, not more than 1.1%, not more than 1%, not more than 0.9%, not more than 0.8%, not more than 0.7%, or not more than 0.6% by weight, based on the total weight of the cellulose ester dope.

Due to the type of cellulose ester and dissolution solvents that are used, the cellulose dope may exhibit desirable operating viscosities. In one embodiment or in combination with any other mentioned embodiments, the cellulose ester dope may exhibit a viscosity of at least 10 poise, at least 20 poise, at least 30 poise, at least 40 poise, at least 50 poise, at least 60 poise, at least 70 poise, at least 80 poise, at least 90 poise, or at least 100 poise and/or not more than 3,000 poise, not more than 2,000 poise, not more than 1,500 poise, not more than 1,000 poise, not more than 950 poise, not more than 900 poise, not more than 850 poise, not more than 800 poise, not more than 750 poise, not more than 700 poise, not more than 650 poise, not more than 600 poise, not more than 550 poise, or not more than 500 poise when measured at the spinning temperature used for manufacturing the fiber. This spinning temperature is nominally the temperature of the dope as it passes through and into the spinneret. The viscosity defined herein is the “zero” shear viscosity obtained by extrapolating to a very low shear rate when viscosity is plotted versus shear rate, or alternately by using a Brookfield viscometer at low spindle RPM. Thus, the “when measured” threshold does not in any manner reflect the use or practice of the actual cellulose ester dope.

In one embodiment or in combination with any other mentioned embodiments, the cellulose ester dope may exhibit a viscosity of at least 10 poise, at least 20 poise, at least 30 poise, at least 40 poise, at least 50 poise, at least 60 poise, at least 70 poise, at least 80 poise, at least 90 poise, or at least 100 poise and/or not more than 5,000 poise, not more than 4,000 poise, not more than 3,000 poise, not more than 2,000 poise, not more than 1,500 poise, not more than 1,000 poise, not more than 950 poise, not more than 900 poise, not more than 850 poise, not more than 800 poise, not more than 750 poise, not more than 700 poise, not more than 650 poise, not more than 600 poise, not more than 550 poise, or not more than 500 poise when measured at 25 °C, 50 °C, 60 °C, 70 °C, 80 °C, 90 °C, 100 °C, or 110 °C. It should be noted that this “when measured” standard does not require the cellulose ester dope to be utilized only at this designated temperature; rather, this temperature standard simply provides a temperature threshold at which to measure the viscosity of the cellulose ester dope. Thus, the “when measured” threshold does not in any manner reflect the use or practice of the actual cellulose ester dope. The viscosity may be measured using a Brookfield viscometer at low spindle RPM.

In one embodiment or in combination with any other mentioned embodiments, the cellulose ester dope may comprise some or no additives in addition to the cellulose ester. Such additives can include, but are not limited to, plasticizers, antioxidants, thermal stabilizers, pro-oxidants, inorganics, pigments, colorants, or combinations thereof.

In one embodiment or in combination with any other mentioned embodiments, the dope comprises no more than 10%, no more than 5%, no more than 3%, no more than 2%, no more than 1%, or 0% by weight polymers that are not cellulose esters, based on the total solids in the dope.

In one embodiment or in combination with any other mentioned embodiments, the dope comprises no more than 10%, no more than 5%, no more than 3%, no more than 2%, no more than 1%, or 0% by weight additives, based on the total solids in the dope. Examples of such additives include metal oxides, delusterants, plasticizers, water, biodegrading-enhancing agents, and/or fiber lubricants . . . . Depending on the embodiment, the dope comprises any one or more of the foregoing % by weight ranges when combining the total weight in the dope of one, two, three, four, five, or all of the metal oxides, delusterants, plasticizers, water, biodegrading-enhancing agents, and/or fiber lubricants.

In one embodiment or in combination with any other mentioned embodiments, the dope comprises no more than 10%, no more than 5%, no more than 3%, no more than 2%, no more than 1%, or 0% by weight of the combination of additives and polymers that are not cellulose esters, based on the total solids in the dope.

In one embodiment or in combination with any other mentioned embodiments, the dope is prepared by mixing the cellulose ester, solvent, and any other components at lower temperatures. In certain embodiments, this mixing is performed by mixing at a temperature of at least 45 °C, at least 46 °C, at least 47 °C, at least 48 °C, at least 49 °C, at least 50 °C, at least 51 °C, at least 52 °C, at least 53 °C, at least 54 °C, at least 55 °C, at least 56 °C, at least 57 °C, at least 58 °C, at least 59 °C, or at least 60 °C and/or not more than 140 °C, not more than 130 °C, not more than 120 °C, not more than 110 °C, not more than 105 °C, not more than 104 °C, not more than 103 °C, not more than 102 °C, not more than 101 °C, not more than 100 °C, not more than 99 °C, not more than 98 °C, not more than 97 °C, not more than 96 °C, or not more than 95 °C. In certain embodiments, this temperature is 45 °C to 140 °C, 45 °C to 105 °C, 47 °C to 103 °C, or 50 °C to 100 °C.

In one embodiment or in combination with any other mentioned embodiments, this mixing is carried out for at least 5 minutes, at least 6 minutes, at least 8 minutes, at least 10 minutes, at least 12 minutes, at least 14 minutes, or at least 15 minutes and/or not more than 48 hours, not more than 36 hours, not more than 24 hours, not more than 20 hours, not more than 16 hours, not more than 12 hours, or not more than 8 hours. In certain embodiments, this time is 5 minutes to 48 hours, 5 minutes to 36 hours, 5 minutes to 24 hours, or 5 minutes to 8 hours.

After forming the cellulose ester dope, it may be routed to an optional dope holding tank for temporary storage and/or deaeration. The dope holding tank can comprise any conventional storage tank known in the art that is capable of storing the cellulose ester dope. While stored in the holding tank, the cellulose ester dope may be subjected to conditions facilitated to maintain the physical characteristics of the dope and/or remove gas bubbles introduced during the mixing step. The temperature and pressure of the holding and/or deaeration tank may be optimized as necessary to enhance and maintain the quality of the cellulose ester dope.

Next, the cellulose ester dope can be pumped out of the dope holding tank into a filter, which may remove any large and undesirable particulates and gels from the cellulose ester dope prior to spinning. The filter can comprise any conventional filter apparatus and filter type known in the art. After filtering, the filtered cellulose ester dope may be pumped to a spinneret positioned near or in an evaporation chamber or cabinet for dry spinning, or near a coagulation bath for wet spinning.

The cellulose ester dope may be metered through the spinneret to thereby form one or more fibers. The shape and size of the hole or holes in the spinneret help determine the cross section of the fiber(s). The number of holes in the spinneret face determines the number of fibers simultaneously formed as dope is metered into the spinneret. As the dope passes through the holes in the spinneret face, the individual fibers form.

More particularly, in one embodiment or in combination with any other mentioned embodiments, the cellulose ester dope can be spun at a rate of 10 to 1000 m/min through spinneret holes having a design known in the art (e.g., having a hole area equivalent to a circular diameter of 20 to 200 microns). In one embodiment or in combination with any other mentioned embodiments, the spinneret may be maintained at a temperature of at least 50 °C, at least 55 °C, at least 60 °C, at least 65 °C, at least 70 °C, or at least 75 °C and/or not more than 175 °C, not more than 170 °C, not more than 165 °C, not more than 160 °C, not more than 155 °C, or not more than 150 °C. In certain embodiments, the head of the spinneret may be maintained at a temperature in the range of 50 °C to 175 °C, 75 °C to 175 °C, 85 °C to 165 °C, 95 °C to 160 °C, or 100 °C to 150 °C.

At the spinneret, the cellulose ester dope can be extruded through a plurality of holes to form continuous cellulose ester fibers. At the spinneret, fibers may be drawn to form bundles of multiple individual fibers, or hundreds of individual fibers, or even one thousand individual fibers. Each of these bundles may include at least 10, at least 20, at least 30, at least 40, at least 50, at least 60, at least 70, at least 80, at least 90, at least 100, at least 150, at least 200, at least 250, at least 300, at least 350, or at least 400 and/or not more than 1,000, not more than 900, not more than 800, not more than 700, or not more than 600 fibers. The spinneret may be operated at any speed suitable to produce individual filament fibers, which are then assembled into bundles having desired size and shape. As used herein, the term “individual filament fiber” refers to the continuous filament that is initially produced by each hole in the face of the spinneret.

For dry spinning, the fibers are extruded through the spinneret into a vertical spinning cabinet, which may have walls that are nominally 150 °C to 240 °C and which may contain gases inside the cabinet that are nominally 200-500 °C, where the solvent is flashed off or evaporated. In certain embodiments, evaporating comprises exposing the spun fibers to temperatures of at least 100 °C, at least 110 °C, at least 120 °C, at least 130 °C, at least 140 °C, at least 145 °C, at least 150 °C, at least 153 °C, at least 155 °C, at least 160 °C, at least 165 °C, at least 170 °C, at least 175 °C, at least 180 °C, at least 185 °C, or at least 189 °C and/or not more than 500 °C not more than 400 °C, not more than 375 °C, not more than 350 °C, not more than 325 °C, not more than 300 °C, not more than 275 °C, not more than 250 °C, not more than 240 °C, not more than 230 °C, or not more than 220 °C. In certain embodiments, this temperature is 100 °C to 500 °C, 110 °C to 400 °C, 120 °C to 375 °C, 130 °C to 350 °C, 140 °C to 300 °C, or 150 °C to 250 °C.

For wet spinning, the fibers may be drawn through a coagulation bath comprising a coagulation solvent formed from water or a blend of water and an additional solvent.

It should be noted that the cellulose ester fibers formed may be in the form of monocomponent fibers that are formed from only one material (e.g., the cellulose ester) or a uniformly blended composition and, therefore, would not be considered “bicomponent” or “multicomponent fibers,” which are characterized by internal phases or boundaries delineating different compositions within the external surface of the fiber. In one embodiment or in combination with any other mentioned embodiments, the resulting cellulose ester fibers can comprise at least 50%, at least 55%, at least 60%, at least 65%, at least 70%, at least 75%, at least 80%, at least 85%, at least 90%, at least 95%, at least 99%, or at least 99.9% by weight of the cellulose ester, based on the total weight of the fiber. In certain embodiments, the cellulose ester fiber can be formed entirely from the cellulose ester.

The individual cellulose ester fibers discharged from the spinneret, may have any suitable transverse cross-sectional shape. Exemplary cross-sectional shapes include, but are not limited to, round or other than round (non-round). In one embodiment or in combination with any other mentioned embodiments, the individual fibers discharged from the spinneret may have a substantially round cross-sectional shape. As used herein, the term “cross-section” generally refers to the transverse cross-section of the fiber measured in a direction perpendicular to the direction of elongation of the fiber. The cross-section of the fiber may be determined and measured using Quantitative Image Analysis (“QIA”).

The cross-sectional shape of an individual fiber may also be characterized according to its deviation from a round cross-sectional shape. In some cases, this deviation can be characterized by the shape factor of the fiber, which is determined by the following formula: Shape Factor=Perimeter/(4π×Cross-Sectional Area)^{1/2}. In some embodiments, the shape factor of the individual cellulose ester fibers can be from 1 to 2, 1 to 1.8, 1 to 1.7, 1 to 1.5, 1 to 1.4, 1 to 1.25, 1 to 1.15, or 1 to 1.1. The shape factor of a fiber having a perfect round cross-sectional shape is 1. The shape factor can be calculated from the cross-sectional area of the fiber, which can be measured using QIA.

Furthermore, in certain embodiments, the cellulose ester fibers may be in the form of solid fibers (fibers having a solid cross-sectional shape without an aperture present therein) and not in the form of hollow fibers.

In one embodiment or in combination with any other mentioned embodiments, at least 20%, at least 40%, at least 60%, at least 80%, or at least 100% by weight of the cellulose in the fibers may be from a pre-consumer textile waste source.

In one embodiment or in combination with any other mentioned embodiments, the cellulose ester fibers and/or the yarn produced therefrom may exhibit a tenacity of at least 0.2 g/denier, at least 0.3 g/denier, at least 0.4 g/denier, at least 0.5 g/denier, at least 0.6 g/denier, at least 0.7 g/denier, at least 0.8 g/denier, at least 0.9 g/denier, at least 1 g/denier, at least 1.1 g/denier, at least 1.2 g/denier, at least 1.3 g/denier, at least 1.4 g/denier, at least 1.5 g/denier, at least 1.6 g/denier, at least 1.7 g/denier, at least 1.8 g/denier, at least 1.9 g/denier, or at least 2 g/denier, and/or not more than 3.0, or not more than 2.5, not more than 2.3, not more than 2.1, not more than 2, or not more than 1.9 g/denier, as measured according to ASTM D22556.

Elongation, also known as elongation at break, is expressed as a percentage and it is indicative of how much a yarn or filament will stretch before it breaks. In one embodiment or in combination with any other mentioned embodiments, the cellulose ester fibers and/or the yarn produced therefrom may exhibit an elongation at break of at least 10%, at least15%, at least 16%, at least 17%, at least 18%, at least 19%, at least 20%, at least 21%, at least 22%, at least 23%, at least 24%, at least 25%, at least 26%, at least 27%, at least 28%, at least 29%, or at least 30% as measured according to ASTM D22556.

Silk factor (“SF”) is an empirically determined relationship between tenacity and elongation that is used to predict the failure envelope of a given fiber. Silk Factor can be used to characterize a yarn or fiber's suitability for use in a given process and is calculated based on the following formula:

Silk Factor=Tenacity*\sqrt{Elongation}

In one embodiment or in combination with any other mentioned embodiments, the cellulose ester fibers and/or the yarn produced therefrom may exhibit a silk factor of at least 5.0, at least 6.0, at least 7.0, or at least 7.6, where elongation is defined as a percentage and tenacity is in grams/denier.

In one embodiment or in combination with any other mentioned embodiments, the cellulose ester fibers and/or the yarns formed therefrom can be biodegradable. As used herein, the term “biodegradable” generally refers to the tendency of a material to chemically decompose under certain environmental conditions. The degree of degradation can be characterized by the weight loss of a sample over a given period of exposure to certain environmental conditions. In some cases, the cellulose ester fibers and/or the yarns formed therefrom can exhibit a weight loss of at least 5%, at least 10%, at least 15%, or at least 20% after burial in soil for 60 days and/or a weight loss of at least 15%, at least 20%, at least 25%, at least 30%, or at least 35% after 15 days of exposure in a composter. However, the rate of degradation may vary depending on the particular end use of the fibers. Exemplary test conditions are provided in U.S. Pat. Nos. 5,870,988 and 6,571,802, incorporated herein by reference.

In one embodiment or in combination with any other mentioned embodiments, the cellulose ester fibers and/or the yarns formed therefrom can be compostable. To be considered “compostable,” a material must meet the following four criteria: (1) the material must be biodegradable; (2) the material must be disintegrable; (3) the material must not contain more than a maximum amount of heavy metals; and (4) the material must not be ecotoxic. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In one embodiment or in combination with any other mentioned embodiments, the cellulose ester fibers and/or the yarns formed therefrom can be industrially compostable, home compostable, or both. In such embodiments, the cellulose ester fibers can satisfy four criteria: (1) biodegrade in that at least 90% carbon content is converted within 180 days; (2) disintegrable in that least 90% the material disintegrates within 12 weeks; (3) does not contain heavy metals beyond the thresholds established under the EN12423 standard; and (4) the disintegrated content supports future plant growth as humus; where each of these four conditions are tested per the ASTM D6400, ISO 17088, or EN 13432 method.

In one embodiment or in combination with any other mentioned embodiments, the cellulose ester fibers and/or the yarns formed therefrom can exhibit a biodegradation of at least 70 percent in a period of not more than 50 days, when tested under aerobic composting conditions at ambient temperature (28 °C±2 °C) according to ISO 14855-1 (2012). In some cases, the cellulose ester fibers and/or the yarns formed therefrom can exhibit a biodegradation of at least 70 percent in a period of not more than 49, not more than 48, not more than 47, not more than 46, not more than 45, not more than 44, not more than 43, not more than 42, not more than 41, not more than 40, not more than 39, not more than 38, or not more than 37 days when tested under these conditions, also called “home composting conditions.” These conditions may not be aqueous or anaerobic.

In one embodiment or in combination with any other mentioned embodiments, the cellulose ester fibers and/or the yarns formed therefrom can exhibit a biodegradation of at least 60 percent in a period of not more than 45 days, when tested under aerobic composting conditions at a temperature of 58 °C (±2 °C) according to ISO 14855-1 (2012). In some cases, they can exhibit a biodegradation of at least 60 percent in a period of not more than 44 days when tested under these conditions, also called “industrial composting conditions.” These may not be aqueous or anaerobic conditions.

The newly-formed fibers may be accumulated onto cores or tubes at a winder after evaporation or solvent flash-off and may be sent to optional downstream processes. The fibers may be wrapped around a take-up roll, which provides tension and pulls the fibers into the downstream steps of the process, which may include, for example, one or more annealing sections, a winder, a crimper, a cutter, or a combination thereof.

The formed cellulose ester fibers may be gathered into a bundle, band, or yarn. The bundle, band, or yarn may comprise a plurality of the cellulose ester fibers. Each of these bundles, bands, or yarns may include at least 15, at least 20, at least 30, at least 40, at least 50, at least 60, at least 70, at least 80, at least 90, at least 100, at least 150, at least 200, at least 250, at least 300, at least 350, or at least 400 and/or not more than 70,000, not more than 60,000, not more than 50,000, not more than 40,000, not more than 30,000, not more than 20,000, not more than 15,000, not more than 10,000, not more than 5,000, not more than 1,000, not more than 900, not more than 800, not more than 700, or not more than 600 individual fibers.

In one embodiment or in combination with any other mentioned embodiments, the cellulose ester fibers and/or the cellulose ester bundle, band, or yarn may be passed through a crimping zone wherein a patterned wavelike shape may be imparted to at least a portion, or substantially all, of the individual fibers. When used, the crimping zone includes at least one crimping device for mechanically crimping the fibers. Generally, the cellulose ester fibers desirably are not crimped by thermal or chemical means (e.g., hot water baths, steam, air jets, or chemical coatings), but instead are mechanically crimped using a suitable crimper. One example of a suitable type of mechanical crimper is a “stuffing box” or “stuffer box” crimper that utilizes a plurality of rollers to generate friction, which causes the fibers to buckle and form crimps. Other types of crimpers may also be suitable. Examples of equipment suitable for imparting crimp fibers are described in, for example, U.S. Pat. Nos. 9,179,709; 2,346,258; 3,353,239; 3,571,870; 3,813,740; 4,004,330; 4,095,318; 5,025,538; 7,152,288; and 7,585,442, each of which is incorporated herein by reference to the extent not inconsistent with the present disclosure.

In one embodiment or in combination with any other mentioned embodiments, crimping may be performed such that the cellulose ester fibers have a crimp frequency of at least 5, at least 7, at least 10, at least 12, at least 13, at least 15, or at least 17 and/or up to 30, up to 27, up to 25, up to 23, up to 20, or up to 19 crimps per inch (“CPI”), as measured according to ASTM D3937-12. In certain embodiments, the average CPI of the fibers used to make the cellulose ester bundle, band, or yarns and/or various downstream products may be in the range of 7 to 30 CPI, 10 to 30 CPI, 10 to 27 CPI, 10 to 25 CPI, 10 to 23 CPI, 10 to 20 CPI, 12 to 30 CPI, 12 to 27 CPI, 12 to 25 CPI, 12 to 23 CPI, 12 to CPI, 15 to 30, CPI, 15 to 27 CPI, 15 to 23 CPI, 15 to 20 CPI, or 15 to 19 CPI.

In one embodiment or in combination with any other mentioned embodiments, when crimped, the crimp amplitude of the fibers may vary and can, for example, be at least 0.85, 0.90, 0.93, 0.96, 0.98, 1.00, or 1.04 mm. Additionally or alternatively, in one embodiment or in combination with any other mentioned embodiments, the crimp amplitude of the fibers can be up to 1.75, up to 1.70, up to 1.65, up to 1.55, up to 1.35, up to 1.28, up to 1.24, up to 1.15, up to 1.10, up to 1.03, or up to 0.98 mm.

Additionally, in one embodiment or in combination with any other mentioned embodiments, the cellulose ester fibers, the cellulose ester bundle, band, or yarn, and/or staple fibers produced therefrom may have a crimp ratio of at least 1:1. As used herein, “crimp ratio” refers to the ratio of the non-crimped tow length to the crimped tow length. In certain embodiments, the cellulose ester fibers, the cellulose ester yarns, and/or staple fibers produced therefrom may have a crimp ratio of at least 1:1, at least 1.1:1, at least 1.125:1, at least 1.15:1, or at least 1.2:1.

Crimp amplitude and crimp ratio are measured according to the procedure outlined in U.S. Pat. App. Pub. No. 2020/0299822, which is incorporated herein by reference to the extent not inconsistent with the present disclosure.

Additionally or alternatively, in one embodiment or in combination with any other mentioned embodiments, one or more types of surface finish may be applied to the cellulose ester fibers and/or the bundle, band, or yarn formed therefrom. The method of application is not limited and can include the use of spraying, wick application, dipping, or use of squeeze, lick, or kiss rollers. The location for applying a finish to a fiber can vary depending on the function of the finish. For example, the lubricant finish can be applied after spinning and before crimping, or before gathering the fibers into a bundle. Cutting lubricants and/or antistatic lubricants can be applied before or after crimping and prior to drying. Suitable amounts of all finishes (whether lubricant, cutting lubricant, antistatic electricity finish, or otherwise) on the cellulose ester fibers can be at least 0.01, at least 0.02, at least 0.05, at least 0.10, at least 0.15, at least 0.20, at least 0.25, at least 0.30, at least 0.35, at least 0.40, at least 0.45, at least 0.50, at least 0.55, or at least 0.60 percent finish-on-yarn (“FOY”) relative to the weight of the dried cellulose ester fiber. Additionally or alternatively, in one embodiment or in combination with any other mentioned embodiments, the cumulative amount of finish may be present in an amount of not more than 2.5, not more than 2.0, not more than 1.5, not more than 1.2, not more than 1.0, not more than 0.9, not more than 0.8, or not more than 0.7 percent FOY based on the total weight of the dried fiber. The amount of finish on the fibers as expressed by weight percent may be determined by solvent extraction. As used herein “FOY” or “finish on yarn” refers to the amount of finish on the fiber or yarn less any added water.

In one embodiment or in combination with any other mentioned embodiments, the cellulose ester fibers can include at least one plasticizer or, in the alternative, no plasticizer. The cellulose ester fibers may comprise less than 30, less than 12, less than 10, less than 9, less than 8, less than 7, less than 6, less than 5, less than 4, less than 3, less than 2, less than 1, less than 0.5 weight percent of at least one plasticizer, based on the total weight of the cellulose ester fiber. When present, the plasticizer may be incorporated into the fiber itself by spinning a dope containing a plasticizer, contained in a flake used to make the dope, and/or the plasticizer may be applied to the surface of the fiber or filament by any of the methods used to apply a finish. If desired, the plasticizer can be contained in the finish formulation.

The resulting cellulose ester fibers may be used to produce a vast array of intermediate fiber products, such as tow band, staple fibers, filaments, bundles, slivers, bobbins, rovings, yarns, and/or bales, and end products such as fabrics, textiles, woven articles (e.g., woven fabrics or textiles), nonwoven articles (e.g., nonwoven webs, fabrics, or textiles), knitted textiles, tobacco filters, and/or heat-not-burn tobacco products.

In one embodiment or in combination with any other mentioned embodiments, the cellulose ester fibers and/or the cellulose ester yarns described above may be cut into staple fibers. Any suitable type of cutting device may be used that is capable of cutting the fibers to a desired length without excessively damaging the fibers. Examples of cutting devices can include, but are not limited to, rotary cutters, guillotines, stretch breaking devices, reciprocating blades, or combinations thereof. Once cut, the cellulose ester staple fibers may be baled or otherwise bagged or packaged for subsequent transportation, storage, and/or use. In one embodiment or in combination with any other mentioned embodiments, the d50 length of the staple fibers may be at least 10, at least 20, at least 30, at least 40, or at least 50 mm and/or not more than 450, not more than 400, not more than 350, not more than 300, not more than 250, not more than 200, not more than 150, not more than 115, not more than 110, not more than 105, not more than 100, or not more than 95 mm.

Additionally or alternatively, in one embodiment or in combination with any other mentioned embodiments, the denier per filament (weight in g of 9000 m fiber length), or “DPF,” of the cellulose ester fibers (whether cellulose ester staple fibers or cellulose ester continuous fibers) may be within a range of 0.5 to less than 30, or 0.5 to less than 20. The particular method for measurement is not limited and include the ASTM 1577-07 method using the FAVIMAT vibroscope procedure if filaments can be obtained from which the staple fibers are cut, a microbalance weight measurement of a sample of known length, or a width analysis using any convenient optical microscopy or analyzer. The DPF can also be correlated to the maximum width of a fiber.

In one embodiment or in combination with any other mentioned embodiments, the staple fibers can be formed into a cellulose ester spun yarn. Spun yarns are continuous strands comprising short staple fibers which are mechanically entangled by a staple yarn spinning process. Staple yarn spinning processes can be, but are not limited to, ring spinning, open-end spinning, air jet spinning, compact spinning, siro spinning, vortex spinning, worsted spinning, semi-worsted spinning, woolen spinning, and wet spinning with flax.

In one embodiment or in combination with any other mentioned embodiments, the cellulose ester fibers may be formed into a nonwoven article, such as a nonwoven textile. Exemplary nonwoven articles can include wet-laid nonwoven articles, air-laid non-woven articles, carded articles, and/or dry-laid non-woven articles.

In one embodiment or in combination with any other mentioned embodiments, the cellulose ester yarns may be formed into a woven article, such as a woven textile. Woven textiles can be formed on a loom by interlacing at least two yarns, a warp yarn, and a weft yarn, wherein the warp yarn strands are oriented in parallel, and the weft yarns are interlaced at an angle to the orientation of the warp yarns in an alternating pattern over and under the warp yarns.

In one embodiment or in combination with any other mentioned embodiments, the cellulose ester yarns may be formed into a knitted article, such as a knitted textile. Such knitted textiles may be formed by interlocking loops of yarn.

In one embodiment or in combination with any other mentioned embodiments, the end products described herein, including the staple fibers, yarns, nonwoven articles, knitted articles, and the woven articles, may comprise, consist essentially of, or consist of the cellulose ester fibers. The end products described herein, including the staple fibers, yarns, nonwoven articles, knitted articles, and the woven articles, may comprise at least 0.25, at least 0.5, at least 0.75, at least 1, at least 2, at least 3, at least 4, at least 5, at least 6, at least 7, at least 8, at least 9, at least 10, at least 12, at least 15, at least 18, at least 20, at least 25, at least 30, at least 35, at least 40, at least 45, at least 50, at least 55, at least 60, at least 65, at least 70, at least 75, at least 80, at least 85, at least 90, at least 95, at least 99, or at least 99.9 weight percent of one or more cellulose ester fibers, based on the total weight of the article. Additionally or alternatively, in one embodiment or in combination with any other mentioned embodiments, the end products described herein, including the staple fibers, yarns, nonwoven articles, knitted articles, and the woven articles, may comprise not more than 99, not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 9, not more than 8, not more than 7, not more than 6, or not more than 5 weight percent of one or more cellulose ester fibers, based on the total weight of the article. In certain embodiments, the end products may be formed entirely from the cellulose ester fibers or comprise in the range of 0.25 to 50, 1 to 99, 1 to 50, 50 to 99, 1 to 20, or 0.25 to 5 weight percent of one or more cellulose ester fibers, based on the total weight of the article.

In one embodiment or in combination with any other mentioned embodiments, the end products described herein may have one, two, three, or four of the properties of Table B, in any combination. In one embodiment or in combination with any other mentioned embodiments, the end products will have all five properties of Table B.

TABLE B

| | | | | |
|---|---|---|---|---|
| Average ΔE | less than | less than | less than | less than |
| CMC of ivory | 0.65 | 0.55% | 0.45% | 0.35 |
| data point | | | | |
| Average ΔE | less than | less than 1 | less than 0.8 | less than 0.5 |
| CMC of | 1.25 | | | |
| harvest gold | | | | |
| data point | | | | |
| Average ΔΕ | less than 1 | less than 0.8 | less than 0.6 | less than |
| CMC of black | | | | 0.45 |
| data point | | | | |
| Average ΔE | less than | less than 1.1 | less than 1 | less than |
| CMC of gray | 1.3 | | | 0.90 |
| data point | | | | |
| Average ΔE | less than 1 | less than 0.9 | less than 0.8 | Less than 0.5 |
| CMC of all | | | | |
| gray data | | | | |
| points | | | | |

*Determined as described in Example 3.

Each of the documents of Table C are incorporated by reference in their entireties, to the degree that they do not contradict the statements made herein. Additionally, any one or more of the embodiments disclosed in any one or more of the documents of Table C may be used in combination with each other and/or in combination with one or more of the embodiments disclosed herein, to the extent such a combination doesn't contradict a statement made herein.

TABLE C

| Filing | Publication | Patent | |
|---|---|---|---|
| Date | Number | Number | Title |
| Feb. 4, 2019 | WO2020/1693255 | | GASIFICATION OF TIRES AND SOLID |
| | | | FOSSIL FUELS |
| Feb. 4, 2019 | WO2020/163259 | | CELLULOSE ESTER COMPOSITIONS |
| | | | DERIVED FROM POST-CONSUMER |
| | | | TIRE CONTENT SYNGAS |
| Feb. 4, 2019 | US2020-0248083 | | GASIFICATION OF POST- |
| | | | CONSUMER TIRES AND SOLID |
| | | | FOSSIL FUELS TO PRODUCE |
| | | | ORGANIC COMPOUNDS |
| Feb. 4, 2019 | US2020-0248084 | | GASIFICATION OF TIRES AND SOLID |
| | | | FOSSIL FUELS IN A PERMITTED |
| | | | GASIFIER |
| Feb. 4, 2019 | | US11370983 | GASIFICATION OF PLASTICS AND |
| | | | SOLID FOSSIL FUELS |
| | US2022-0169933 | US11286436 | FEED LOCATION FOR GASIFICATION |
| | | | OF PLASTICS AND SOLID FOSSIL |
| | | | FUELS |
| Feb. 4, 2019 | US2022-0213397 | US11312914 | GASIFICATION OF PLASTICS AND |
| | | | SOLID FOSSIL FUELS TO PRODUCE |
| | | | ORGANIC COMPOUNDS |
| Feb. 4, 2019 | US2020-0247910 | | CELLULOSE ESTER COMPOSITIONS |
| | | | DERIVED FROM RECYCLED PLASTIC |
| | | | CONTENT SYNGAS |
| Mar. 26, 2019 | WO2020/205392 | | GASIFICATION OF SIZE REDUCED |
| | | | TEXTILES AND SOLID FOSSIL FUELS |
| Mar. 26, 2019 | WO2020/205410 | | GASIFICATION OF SIZE REDUCED |
| | | | TEXTILES AND SOLID FOSSIL FUELS |
| | | | TO PRODUCE ORGANIC |
| | | | COMPOUNDS |
| Mar. 26, 2019 | WO2020/205414 | | POLYMERS, CHEMICALS, AND |
| | | | ARTICLES OBTAINED FROM SIZE |
| | | | REDUCED TEXTILE DERIVED |
| | | | SYNGAS |
| Mar. 26, 2019 | US2022-0135893 | | GASIFICATION OF DENSIFIED |
| | | | TEXTILES AND SOLID FOSSIL FUELS |
| Mar. 26, 2019 | US2022-0177790 | | GASIFICATION OF DENSIFIED |
| | | | TEXTILES AND SOLID FOSSIL FUELS |
| | | | TO PRODUCE ORGANIC |
| | | | COMPOUNDS |
| Mar. 26, 2019 | US2022-0119987 | | POLYMERS, ARTICLES, AND |
| | | | CHEMICALS MADE FROM DENSIFIED |
| | | | TEXTILE DERIVED SYNGAS |
| Apr. 23, 2019 | US2022-0169931 | | GASIFICATION OF TORRIFIED |
| | | | TEXTILES AND SOLID FOSSIL FUELS |
| Mar. 26, 2019 | WO2020/205405 | | CAMPAIGNING GASIFICATION OF |
| | | | TEXTILES AND PLASTICS AND |
| | | | SOLID FOSSIL FUELS |
| Mar. 26, 2019 | WO2020/205396 | | CAMPAIGNING GASIFICATION OF |
| | | | TEXTILES AND PLASTICS AND |
| | | | SOLID FOSSIL FUELS TO PRODUCE |
| | | | ORGANIC COMPOUNDS |
| Mar. 26, 2019 | US2022-0162344 | | POLYMERS, CHEMICALS, AND |
| | | | ARTICLES OBTAINED FROM |
| | | | GASIFYING HIGH |
| | | | CONCENTRATIONS OF WASTE |
| | | | PLASTIC AND TEXTILES |

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” “comprise,” “contain,” “containing,” and “contains” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

Additionally, it should be understood that a listing of numerical values following a descriptor, such as “at least” and “not more than,” provides literal support for a range based on all of the numerical values following that descriptor. For example, a statement specifying “at least 2, 5, or 10 and/or not more than 100, 50, or 25” would provide literal support for ranges of “at least 25,” “not more than 50,” and “at least 10 and not more than 25.”

### EXAMPLES

The following examples set forth methods in accordance with the disclosure. It is to be understood, however, that these examples are provided by way of illustration, and nothing therein should be taken as a limitation upon the overall scope.

### Example 1

### Flake Preparation and Characterization

### 1. Flake Preparation

A pulp roll comprising cotton linters as the pre-consumer textile waste was shredded, and the shreds were steeped in glacial acetic acid. After steeping, the cellulose present in the shreds was acetylated with acetic anhydride followed by partial hydrolysis in the presence of sulfuric acid. Cellulose diacetate flakes were recovered from solution, washed, and dried. This process was repeated three times to generate four cellulose diacetate samples whose cellulose was derived entirely from cotton linters.

### 2. Acetyl Content and Intrinsic Viscosity of Flakes

The samples were analyzed for acetyl content and intrinsic viscosity (“IV”) and compared to a control, which was cellulose diacetate made by the same process except using 100% wood pulp.

To determine acetyl content, each flake sample was dissolved in acetone by stirring. After dissolution, the sample solution was injected into a liquid chromatography system, where the polymer was separated by reversed-phase liquid chromatography based on the degree of substitution. An evaporative light scattering detector was used for quantification. The calculations used are as follows:
Percent Acetyl
Wt % Acetyl=m×CT+b
Where:
Wt % Acetyl=Weight percent acetyl
m=calibration slope in units of wt % acetyl min-1
CT=peak centroid time of polymer sample in minutes
b=y-intercept of calibration line in units of wt % acetyl
Relative Acetyl Spread

$$RAS = \frac{WDs}{WDc}$$

Where:
RAS=relative acetyl spread
WDs=Width in time of the sample peak at one-tenth height
WDc=Width in time of the control sample peak at one-tenth height

Intrinsic viscosity was determined by first drying the flakes by heating in an MF-50 moisture analyzer for about 5 minutes at 130 °C, followed by heating in a 105 °C oven for 30 minutes. The dried flakes were dissolved in acetone at a concentration of 0.75 g/dL. The samples were individually injected into a relative viscometer in which one capillary measured the pressure of the HPLC grade acetone, and the other capillary measured the pressure of the cellulose acetate and acetone sample solution. The ratio of the values was used to determine the relative viscosity. The calculations were:

$${η}_{rel} = \frac{{η}_{2} ( sample )}{{η}_{1} ( solvent )}$$

### (Viscosity Relative to Solvent)

ηₛₚ=η₂ᵣₑₗ−1

### (Specific Viscosity)

$$[ η ] = \frac{{[ 2 ( {η}_{sp} - ln {η}_{rel} ]}^{0.5}}{c}$$

### (Solomon-Gatesman Equation for Intrinsic Viscosity)

In the above formula, “c” is the viscometer constant defined by the ratio of the two capillaries at base line conditions where the system has solvent flowing in both capillaries at stable pressures.

Table 1 sets forth these results.

TABLE 1

| Sample | | %- | IV |
|---|---|---|---|
| Identifier | Sample Content | Acetyl | (dL/g) |
| 1 | 100% Wood Pulp | 40.12 | 1.51 |
| 2 | 100% Cotton Linter Pulp | 40.09 | 2.08 |
| 3 | 100% Cotton Linter Pulp | 39.33 | 1.84 |
| 4 | 100% Cotton Linter Pulp | 39.79 | 1.58 |
| 5 | 100% Cotton Linter Pulp | 40.12 | 1.74 |
| 6 | Average of Samples #2-5 | 39.83 | 1.81 |
| 7 | Average of Samples #2-5 | 40.24 | 1.57 |
| | (after drying)A | | |
| 8 | Mixture (after drying) of | 39.60 | 1.68 |
| | Equal Parts of Samples | | |
| | #2-5 | | |

^{A}Drying in a rotary cone vacuum dryer at 82° C. until moisture was below 2%.

A blend of 67% by weight Sample #1 flakes (100% wood pulp) and 33% by weight Sample #8 flakes (100% cotton linters) was prepared and analyzed for the acetyl content and intrinsic viscosity. Those results are in Table 2.

TABLE 2

| | %- | IV |
|---|---|---|
| Sample | Acetyl | (dL/g) |
| Sample #8 Remeasure (100% CLP) | 39.63 | 1.69 |
| Sample #9 (Blend-67% #1:33% #8) | 39.88 | 1.72 |

The foregoing shows that using a combination of flakes made from recycled cellulosic material with those made from traditional wood pulp resulted in substantially similar flake properties when compared to flakes made entirely from wood pulp and/or flakes made entirely from cotton linter pulp.

### 3. Polymer Evaluation

The respective molecular weights and polydispersity indices (“PDIs”) of the cellulose diacetates of Samples 2-5 and 8 were determined. Molecular weight was determined by GPC according to ASTM D6474. The molecular weight measurements were used to calculate PDI, which is defined as Mw/Mn.

Table 3 gives those results.

TABLE 3

| | Sample | Sample | Sample | Sample | Sample |
|---|---|---|---|---|---|
| | #2 | #3 | #4 | #5 | #8 |
| Mn | 50989 | 45535 | 48923 | 44644 | 43637 |
| Mw | 134078 | 114945 | 118888 | 116502 | 107451 |
| Mz | 259703 | 216704 | 225080 | 223292 | 202944 |
| PDI | 2.63 | 2.52 | 2.43 | 2.61 | 2.46 |

### Example 2

### Yarn Preparation and Characterization

### 1. Yarn Preparation

Flake Samples 1 (100% wood pulp), 8 (100% cotton linters), and 9 (Blend) from Example 1 were individually dry spun into yarns following the procedure described previously.

### 2. Polymer Evaluation

The respective molecular weights and PDIs of the cellulose diacetates of the yarns formed from Samples 1, 8, and 9 were determined as described in Example 1. Table 4 gives those results.

TABLE 4

| | Sample #1 | Sample #8 | Sample #9 |
|---|---|---|---|
| | Yarn | Yarn | Yarn |
| Mn | 27547 | 28528 | 31551 |
| Mw | 95987 | 95035 | 90681 |
| Mz | 271412 | 258648 | 184139 |
| PDI | 3.48 | 3.33 | 2.87 |

### 3. Chip Whiteness

Yarns of Samples 1, 8, and 9 were analyzed for chip whiteness. A pressed chip was prepared from scoured, dried, ground, and pressed acetate fiber. The sample chip was presented and measured using a spectrophotometer at a wavelength range of 380-700 nm. Whiteness results were generated using the whiteness index based on the CIE Ganz 82 formula . . . .

These results are shown in Table 5.

TABLE 5

| Sample | Chip Whiteness |
|---|---|
| Sample #1 Yarn | 79.3 |
| Sample #8 Yarn | 82.9 |
| Sample #9 Yarn | 83.3 |

Chip whiteness should be 73 or greater, showing that using recycled content as a cellulose source did not negatively affect the yarn.

### 4. Tensile Strength

Yarns of Samples 1, 8, and 9 were analyzed for tensile strength and elongation as described in ASTM D22556. These results are shown in Table 6.

TABLE 6

| | Elongation at | Tenacity |
|---|---|---|
| Sample | Break (%) | (gf/denier) |
| Sample #1 Yarn | 18.5 | 1.25 |
| Sample #8 Yarn | 19.5 | 1.25 |
| Sample #9 Yarn | 19.9 | 1.28 |

### Example 3

### Fabric Preparation and Dye Uptake Analysis

### 1. Fabric Preparation

Yarns from Samples 1 (100% wood pulp), 8 (100% cotton linters), and 9 (Blend) as described in Example 2 were individually knitted into a 100-GSM (±10) single knit jersey using a 9″ diameter 28 gg Vanguard Knitting Machine. The knitted fabrics were heat set in preparation for wet processing. Each pair of specimens that was being compared moved through the wet processing sequence together in the same dyeing vessel. Thus, the two specimens being compared experienced identical knitting, heat setting, and wet processing conditions. To identify whether any wet processing differences existed when the depth of shade was varied, four colors were dyed: ivory, harvest gold, gray, and black. The dyed fabrics were dried and conditioned for dye uptake analysis.

### 2. Fabric Color Comparison

The paired specimens from each dyeing vessel were measured against each other with the control specimen serving as the standard and the experimental specimen serving as the batch. Both the control specimen and the experimental specimen were folded to yield eight layers so that no light was transmitted through the fabric. The color coordinates ΔL, Δa, Δb, and ΔE CMC were recorded for each measurement. ΔL is a measure of lightness difference, Δa is a measure of red/green difference, and Δb is a measure of yellow/blue difference. The ΔE CMC is the total color difference between the two samples measured. This process was repeated with the fabric folded in a different manner, still yielding eight layers, to account for any differences that would result from the fabric being oriented differently.

This process was used to compare the shade impact of using different pulp sources. The three different comparisons were: 100% wood based (0% cotton linter) pulp vs. 100% cotton linter pulp; 100% wood based pulp vs. 33% cotton linter mixed pulp; and 33% cotton linter mixed pulp vs. 100% cotton linter pulp. The process for this study was modified in that the control and experimental specimens were dyed with two wet processing methods employed. The two different conditions are the control and two experimental specimens being included in the same dyeing vessel or the control and only one experimental specimen being included in the same dyeing vessel. The shade data is recorded in Tables 7-9, with the different methods denoted as “2-Way Comparison” or “3-Way Comparison.” The 2-way comparisons yielded better results than the 3-way comparisons in most cases.

These results are shown in Tables 7-9. In each of these Tables, if the standard and batch were designated “statistically equivalent,” this means that:
the ivory data point was below a ΔE CMC of 0.65;
the harvest gold data point was below a ΔE CMC of 1.25;
the black data point was below a ΔE CMC of 0.45;
the gray data points were all below ΔE CMC of 0.90; and
the average ΔE CMC for all gray data points was close to 0.31.

Based on the data from Tables 7-9, pulp source had a statistically significant impact on dye uptake, especially as the cotton linter pulp content is increased.

TABLE 7

| | 0% vs 33% | | | | | | | | | | | |
|---|---|---|---|---|---|---|---|---|---|---|---|---|
| | | | | | | | | | | | ΔE | Average |
| | Standard | Batch | Color | Fold | ΔL | | Δa | | Δb | | CMC | ΔE CMC |
| 3-Way | 0% | 33% | Ivory | A | −0.04 | darker | 0.08 | more red | −0.26 | more blue | 0.27 | 0.32^{A} |
| Comparison | CLP | CLP | | B | 0.12 | lighter | 0.12 | more red | −0.36 | more blue | 0.37 | |
| | 0% | 33% | Harvest | A | 0.24 | lighter | 0.00 | more | 0.10 | more | 0.15 | 0.36^{A} |
| | CLP | CLP | Gold | | | | | green | | yellow | | |
| | | | | B | 0.53 | lighter | −0.21 | more | 0.44 | more | 0.57 | |
| | | | | | | | | green | | yellow | | |
| | 0% | 33% | Black 1 | A | −0.39 | darker | 0.58 | more red | −0.30 | more blue | 0.96 | 0.54^{B} |
| | CLP | CLP | | B | 0.06 | lighter | 0.08 | more red | −0.01 | more blue | 0.12 | |
| 2-Way | 0% | 33% | Black 2 | A | 0.32 | lighter | 0.03 | more red | 0.01 | more | 0.31 | 0.21^{A} |
| Comparison | CLP | CLP | | | | | | | | yellow | | |
| | | | | B | −0.03 | darker | 0.06 | more red | 0.04 | more | 0.10 | |
| | | | | | | | | | | yellow | | |
| 3-Way | 0% | 33% | Gray 1 | A | −0.78 | darker | 1.16 | more red | −0.59 | more blue | 1.77 | 1.58^{C} |
| Comparison | CLP | CLP | | B | 0.05 | lighter | 0.88 | more red | −0.55 | more blue | 1.38 | |
| | 0% | 33% | Gray 2 | A | −1.13 | darker | 0.15 | more red | −0.31 | more blue | 0.69 | 0.58^{A} |
| | CLP | CLP | | B | −0.33 | darker | 0.23 | more red | −0.25 | more blue | 0.47 | |
| | 0% | 33% | Gray 3 | A | −0.83 | darker | 0.69 | more red | −0.36 | more blue | 1.11 | 1.31^{C} |
| | CLP | CLP | | B | −1.56 | darker | 0.83 | more red | −0.56 | more blue | 1.51 | |
| | 0% | 33% | Gray 4 | A | −0.49 | darker | 0.35 | more red | −0.25 | more blue | 0.61 | 0.51^{A} |
| | CLP | CLP | | B | −0.30 | darker | 0.23 | more red | −0.19 | more blue | 0.41 | |
| | 0% | 33% | Gray 5 | A | 0.06 | lighter | −0.42 | more | −0.03 | more blue | 0.57 | 0.51^{A} |
| | CLP | CLP | | | | | | green | | | | |
| | | | | B | −0.50 | darker | 0.17 | more red | −0.23 | more blue | 0.44 | |
| 2-Way | 0% | 33% | Gray 6 | A | −0.54 | darker | 0.32 | more red | −0.39 | more blue | 0.70 | 0.81^{A} |
| Comparison | CLP | CLP | | B | −0.36 | darker | 0.51 | more red | −0.46 | more blue | 0.91 | |
| | 0% | 33% | Gray 7 | A | −0.53 | darker | 0.13 | more red | −0.22 | more blue | 0.41 | 0.45^{A} |
| | CLP | CLP | | B | 0.49 | lighter | 0.21 | more red | −0.25 | more blue | 0.48 | |
| | 0% | 33% | Gray 8 | A | −0.29 | darker | 0.29 | more red | −0.37 | more blue | 0.6 | 0.70^{A} |
| | CLP | CLP | | B | −0.56 | darker | 0.38 | more red | −0.43 | more blue | 0.78 | |

Average ΔE CMC for all Gray Samples 0.80
^{A}Statistically and practically equivalent.
^{B}Statistically different, practically equivalent.
^{C}Statistically and practically different.

TABLE 8

| | 0% vs 100% | | | | | | | | | | | |
|---|---|---|---|---|---|---|---|---|---|---|---|---|
| | | | | | | | | | | | ΔE | Average |
| | Standard | Batch | Color | Fold | ΔL | | Δa | | Δb | | CMC | ΔE CMC |
| 3-Way | 0% | 100% | Ivory | A | −1.11 | darker | 0.34 | more red | −0.75 | more | 0.93 | 0.93^{B} |
| Comparison | CLP | CLP | | | | | | | | blue | | |
| | | | | B | −0.63 | darker | 0.37 | more red | −0.82 | more | 0.93 | |
| | | | | | | | | | | blue | | |
| | 0% | 100% | Harvest | A | −1.24 | darker | 0.37 | more red | 1.14 | more | 1.33 | 1.33^{C} |
| | CLP | CLP | Gold | | | | | | | blue | | |
| | | | | B | −0.62 | darker | 0.79 | more red | −0.78 | more | 1.32 | |
| | | | | | | | | | | blue | | |
| | 0% | 100% | Black | A | 0.16 | lighter | 0.11 | more red | −0.03 | more | 0.22 | 0.51^{B} |
| | CLP | CLP | | | | | | | | blue | | |
| | | | | B | −0.24 | darker | 0.52 | more red | −0.22 | more | 0.80 | |
| | | | | | | | | | | blue | | |
| | 0% | 100% | Gray 1 | A | −1.01 | darker | 0.50 | more red | −1.02 | more | 1.56 | 1.53^{C} |
| | CLP | CLP | | | | | | | | blue | | |
| | | | | B | −0.63 | darker | 0.51 | more red | −0.99 | more | 1.49 | |
| | | | | | | | | | | blue | | |
| | 0% | 100% | Gray 2 | A | −1.44 | darker | 0.64 | more red | −1.06 | more | 1.72 | 1.61^{C} |
| | CLP | CLP | | | | | | | | blue | | |
| | | | | B | −0.69 | darker | 0.54 | more red | −1.01 | more | 1.50 | |
| | | | | | | | | | | blue | | |
| | 0% | 100% | Gray 3 | A | −1.64 | darker | 0.87 | more red | −1.07 | more | 1.97 | 2.09^{C} |
| | CLP | CLP | | | | | | | | blue | | |
| | | | | B | −1.02 | darker | 1.06 | more red | −1.25 | more | 2.20 | |
| | | | | | | | | | | blue | | |
| | 0% | 100% | Gray 4 | A | −1.08 | darker | 0.02 | more red | −0.74 | more | 1.06 | 0.98^{B} |
| | CLP | CLP | | | | | | | | blue | | |
| | | | | B | −0.28 | darker | 0.11 | more red | −0.68 | more | 0.89 | |
| | | | | | | | | | | blue | | |
| | 0% | 100% | Gray 5 | A | −0.86 | darker | 0.47 | more red | −0.75 | more | 1.20 | 1.14^{C} |
| | CLP | CLP | | | | | | | | blue | | |
| | | | | B | −1.45 | darker | 0.17 | more red | −0.64 | more | 1.08 | |
| | | | | | | | | | | blue | | |

Average ΔE CMC for all Gray Samples 1.47
^{B}Statistically different, practically equivalent.
^{C}Statistically and practically different.

TABLE 9

| | 33% vs 100% | | | | | | | | | | | |
|---|---|---|---|---|---|---|---|---|---|---|---|---|
| | | | | | | | | | | | ΔE | Average |
| | Standard | Batch | Color | Fold | ΔL | | Δa | | Δb | | CMC | ΔE CMC |
| 3-Way | 33% | 100% | Ivory | A | −0.65 | darker | 0.08 | more red | −0.17 | more | 0.30 | 0.29^{A} |
| Comparison | CLP | CLP | | | | | | | | blue | | |
| | | | | B | −0.53 | darker | 0.11 | more red | −0.13 | more | 0.28 | |
| | | | | | | | | | | blue | | |
| | 33% | 100% | Harvest | A | −1.38 | darker | 0.09 | more red | −1.04 | more | 1.10 | 1.43^{C} |
| | CLP | CLP | Gold 1 | | | | | | | blue | | |
| | | | | B | −1.51 | darker | 0.59 | more red | −1.43 | more | 1.76 | |
| | | | | | | | | | | blue | | |
| 2-Way | 33% | 100% | Harvest | A | −0.50 | darker | −0.35 | more | −0.65 | more | 0.41 | 0.44^{A} |
| Comparison | CLP | CLP | Gold 2 | | | | | green | | blue | | |
| | | | | B | 0.02 | lighter | 0.10 | more red | −0.51 | more | 0.46 | |
| | | | | | | | | | | blue | | |
| 3-Way | 33% | 100% | Black 1 | A | −0.53 | darker | 0.53 | more red | −0.14 | more | 0.90 | 0.85^{B} |
| Comparison | CLP | CLP | | | | | | | | blue | | |
| | | | | B | −0.46 | darker | 0.47 | more red | −0.10 | more | 0.79 | |
| | | | | | | | | | | blue | | |
| 2-Way | 33% | 100% | Black 2 | A | 0.37 | lighter | 0.17 | more red | −0.17 | more | 0.49 | 0.56^{B} |
| Comparison | CLP | CLP | | | | | | | | blue | | |
| | | | | B | 0.49 | lighter | 0.22 | more red | −0.19 | more | 0.62 | |
| | | | | | | | | | | blue | | |
| 3-Way | 33% | 100% | Gray 1 | A | −0.55 | darker | −0.64 | more | −0.33 | more | 0.99 | 0.91^{B} |
| Comparison | CLP | CLP | | | | | | green | | blue | | |
| | | | | B | 0.04 | lighter | 0.00 | more red | −0.66 | more | 0.82 | |
| | | | | | | | | | | blue | | |
| | 33% | 100% | Gray 2 | A | 0.13 | lighter | −0.20 | more | −0.59 | more | 0.79 | 0.89^{A} |
| | CLP | CLP | | | | | | green | | blue | | |
| | | | | B | −0.67 | darker | 0.14 | more red | −0.74 | more | 0.99 | |
| | | | | | | | | | | blue | | |
| | 33% | 100% | Gray 3 | A | −0.66 | darker | 0.19 | more red | −0.63 | more | 0.88 | 1.01^{C} |
| | CLP | CLP | | | | | | | | blue | | |
| | | | | B | −1.50 | darker | 0.26 | more red | −0.67 | more | 1.14 | |
| | | | | | | | | | | blue | | |
| | 33% | 100% | Gray 4 | A | −0.79 | darker | −0.38 | more | −0.51 | more | 0.90 | 0.84^{A} |
| | CLP | CLP | | | | | | green | | blue | | |
| | | | | B | −0.54 | darker | −0.26 | more | −0.51 | more | 0.78 | |
| | | | | | | | | green | | blue | | |
| | 33% | 100% | Gray 5 | A | −0.79 | darker | −0.15 | more | −0.42 | more | 0.67 | 0.63^{A} |
| | CLP | CLP | | | | | | green | | blue | | |
| | | | | B | −0.39 | darker | −0.15 | more | −0.43 | more | 0.59 | |
| | | | | | | | | green | | blue | | |
| 2-Way | 33% | 100% | Gray 6 | A | −0.77 | darker | 0.25 | more red | −0.60 | more | 0.90 | 0.93^{B} |
| Comparison | CLP | CLP | | | | | | | | blue | | |
| | | | | B | −0.83 | darker | 0.30 | more red | −0.62 | more | 0.96 | |
| | | | | | | | | | | blue | | |
| | 33% | 100% | Gray 7 | A | −0.80 | darker | 0.23 | more red | −0.54 | more | 0.83 | 0.83^{A} |
| | CLP | CLP | | | | | | | | blue | | |
| | | | | B | 0.24 | lighter | 0.34 | more red | −0.55 | more | 0.82 | |
| | | | | | | | | | | blue | | |

Average ΔE CMC for all Gray Samples 0.86
^{A}Statistically and practically equivalent.
^{B}Statistically different, practically equivalent.
^{C}Statistically and practically different.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A process comprising reacting an esterification agent with cellulose to form a cellulose ester, wherein at least a portion of said cellulose is derived from a pre-consumer textile waste.

2. The process according to claim 1, wherein said pre-consumer textile waste is chosen from cotton linters, undercard, fabric clippings, cattle feed waste, comber knolls, pneumafil waste, shoddy waste, yarn waste, production waste, cutter clippings, twisting waste, or mixtures thereof.

3. The process according to claim 1, further comprising, prior to said reacting, mechanically conditioning a dissolving pulp, wherein said dissolving pulp comprises said cellulose.

4. The process according to claim 3, wherein said dissolving pulp is in the form of a sheet or roll, and said mechanically conditioning comprises forming said sheet or roll into smaller pieces.

5. The process according to claim 1, further comprising steeping a dissolving pulp in acetic acid and/or water prior to said reacting.

6. The process according to claim 1, wherein said esterification agent comprises an acetylating agent.

7. The process according to claim 1, wherein said reacting is carried out in the presence of acetic acid, a catalyst, or both acetic acid and a catalyst.

8. The process according to claim 1, wherein said cellulose ester comprises cellulose triacetate, and further comprising hydrolyzing said cellulose triacetate to form cellulose diacetate.

9. The process according to claim 1, further comprising forming said cellulose ester into cellulose ester flakes (I).

10. The process according to claim 9, further comprising mixing said cellulose ester flakes (I) with cellulose ester flakes (II) so as to form a flake blend, wherein said cellulose ester flakes (II) are not formed from cellulose derived from pre-consumer textile waste.

11. The process according to claim 10, wherein if said pre-consumer textile waste comprises cotton linters, said flake blend comprises not more than 95%, not more than 90%, not more than 85%, not more than 80%, not more than 75%, not more than 70%, not more than 65%, or not more than 60% by weight of cellulose ester formed from cellulose derived from cotton linters, based on the total weight of the flake blend.

12. The process according to claim 1, further comprising spinning a cellulose ester dope comprising said cellulose ester through a spinneret to make one or more spun fibers.

13. The process according to claim 12, further comprising at least one of:
evaporating solvent from said one or more spun fibers; or
drawing said one or more fibers through a coagulation bath.

14. A process for producing a cellulose ester fiber, said process comprising:
breaking a roll and/or sheet of a dissolving pulp comprising a recycled pre-consumer textile waste that comprises cellulose into smaller pieces;
reacting said cellulose with an esterification agent so as to form a cellulose ester; and spinning a dope comprising said cellulose ester through a spinneret to make one or more cellulose ester fibers.

15. The process according to claim 14, wherein said pre-consumer textile waste is chosen from cotton linters, undercard, fabric clippings, cattle feed waste, comber knolls, pneumafil waste, shoddy waste, yarn waste, production waste, cutter clippings, twisting waste, or mixtures thereof.

16. The process according to claim 14, further comprising forming said cellulose ester into cellulose ester flakes (I).

17. The process according to claim 14, further comprising mixing said cellulose ester flakes (I) with cellulose ester flakes (II) so as to form a flake blend, wherein said cellulose ester flakes (II) are not formed from cellulose derived from pre-consumer textile waste.

18. The process according to claim 14, wherein if said pre-consumer textile waste comprises cotton linters, said flake blend comprises not more than 95%, not more than 90%, not more than 85%, not more than 80%, not more than 75%, not more than 70%, not more than 65%, or not more than 60% by weight of cellulose ester formed from cellulose derived from cotton linters.

19. A cellulose ester fiber formed according to claim 12.

20. An article comprising a cellulose ester fiber formed according to claim 1.
